(19) United States
(12) Patent Application Publication
(10) Pub. No.: US 2020/0193624 A1
(43) Pub. Date: Jun. 18, 2020

(54) METHOD AND APPARATUS FOR DIMENSIONING OBJECTS

(71) Applicant: Zebra Technologies Corporation, Lincolnshire, IL (US)

(72) Inventors: Aleksandar Rajak, Ottawa (CA); Wenji Xia, Kanata (CA)

(21) Appl. No.: 16/219,701

(22) Filed: Dec. 13, 2018

(51) Int. Cl. G06T 7/521; G06T 7/73; G01B 11/22; G06T 7/13; G01B 11/25

(52) U.S. Cl. CPC G06T 7/521; G06T 7/75; G01B 11/2518; G06T 7/13; G01B 11/22

(57) ABSTRACT

A method of dimensioning an object includes: controlling an image sensor of the dimensioning device to capture image data representing the object; controlling a rangefinder of the dimensioning device to determine an object depth relative to the image sensor; detecting, in the image data, image corners representing corners of the object; determining a ground line and one or more measuring points of the image data based on the detected image corners; determining one or more image dimensions of the object based on the ground line and the one or more measuring points; determining a correspondence ratio of an image distance to an actual distance represented by the image distance based on the object depth, the ground line, and the one or more measuring points; and determining one or more dimensions of the object based on the one or more image dimensions and the correspondence ratio.

### BACKGROUND

Objects such as packages come in all shapes and sizes and may need to be dimensioned, for example for them to be stored. Typically, an operator can dimension an object manually, for example by using a tape measure. Objects may also be stacked onto pallets to be loaded into containers for transport. The pallets may be large, and manual dimensioning can be a time-consuming and error-prone process.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic of a dimensioning system.

FIG. 2A depicts a dimensioning device in the system of FIG. 1.

FIG. 2B is a block diagram of certain internal components of the dimensioning device of FIG. 2A.

FIG. 3 is a flowchart of a method for dimensioning objects in the system of FIG. 1.

FIG. 4 is an example image captured during the performance of the method of FIG. 3.

FIG. 5 is a schematic of a field of view and a laser angle of the dimensioning device of FIG. 2A.

FIG. 6 is a flowchart of a method for determining a dimension during the performance of the method of FIG. 3.

FIG. 7 is a schematic of ground line and measuring point relationships used to determine image dimensions during the performance of the method of FIG. 6.

FIG. 8 is another example image captured during the performance of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method, in a dimensioning device, of dimensioning an object, the method comprising: controlling an image sensor of the dimensioning device to capture image data representing the object; controlling a rangefinder of the dimensioning device to determine an object depth relative to the image sensor; detecting, in the image data, image corners representing corners of the object; determining a ground line and one or more measuring points of the image data based on the detected image corners; determining one or more image dimensions of the object based on the ground line and the one or more measuring points; determining a correspondence ratio of an image distance to an actual distance represented by the image distance based on the object depth, the ground line, and the one or more measuring points; and determining one or more dimensions of the object based on the one or more image dimensions and the correspondence ratio.

Additional examples disclosed herein are directed to a dimensioning device comprising: an image sensor disposed on the dimensioning device, the image sensor configured to capture image data representing an object for dimensioning; a rangefinder disposed on the dimensioning device, the rangefinder configured to determine an object depth relative to the image sensor; and a dimensioning processor coupled to the image sensor and the rangefinder, the dimensioning processor configured to: control the image sensor to capture image data representing the object; control the rangefinder to determine the object depth; detect, in the image data, image corners representing corners of the object; determine a ground line and one or more measuring points of the image data based on the detected image corners; determine one or more image dimensions of the object based on the ground line and the one or more measuring points; determine a correspondence ratio of an image distance to an actual distance represented by the image distance based on the object depth, the ground line, and the one or more measuring points; and determine one or more dimensions of the object based on the one or more image dimensions and the correspondence ratio.

Additional examples disclosed herein are directed to a non-transitory computer-readable medium storing a plurality of computer readable instructions executable by a dimensioning controller, wherein execution of the instructions configures the dimensioning controller to: control an image sensor of a dimensioning device to capture image data representing an object; control a rangefinder of the dimensioning device to determine an object depth relative to the image sensor; detect, in the image data, image corners representing corners of the object; determine a ground line and one or more measuring points of the image data based on the detected image corners; determine one or more image dimensions of the object based on the ground line and the one or more measuring points; determine a correspondence ratio of an image distance to an actual distance represented by the image distance based on the object depth, the ground line, and the one or more measuring points; and determine one or more dimensions of the object based on the one or more image dimensions and the correspondence ratio.

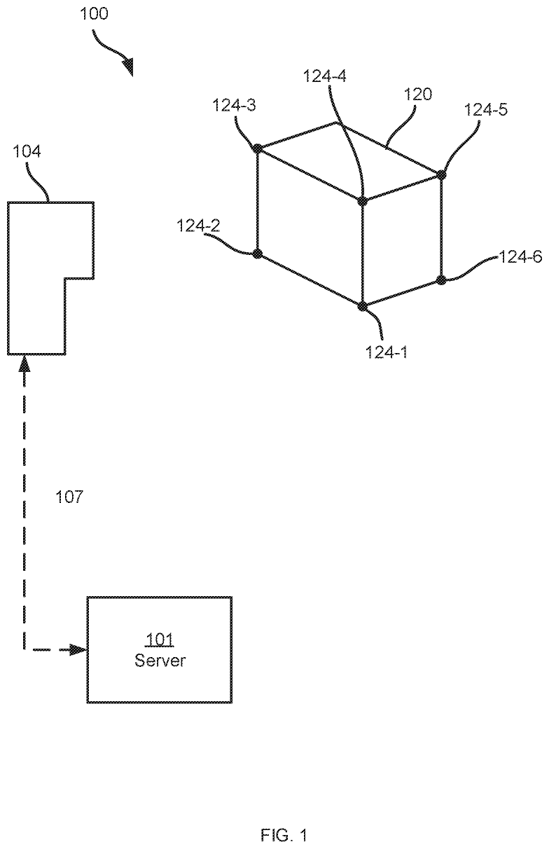

FIG. 1 depicts a dimensioning system 100 in accordance with the teachings of this disclosure. The system 100 includes a server 101 in communication with a dimensioning device 104 (also referred to herein simply as the device 104) via a communication link 107, illustrated in the present example as including wireless links. In the present example, the link 107 is provided by a wireless local area network (WLAN) deployed by one or more access points (not shown). In other examples, the server 101 is located remote from the dimensioning device, and the link 107 therefore includes wide-area networks such as the Internet, mobile networks, and the like.

The system 100 is deployed, in the illustrated example, to dimension a box 120. The box 120 includes corners 124-1, 124-2, 124-3, 124-4, 124-5 and 124-6 (collectively referred to as corners 124, and generically referred to as a corner 124—this nomenclature is also employed for other elements discussed herein). In other examples, the system 100 can be deployed to dimension other objects having a generally rectangular base, such as a pallet including a plurality of stacked boxes.

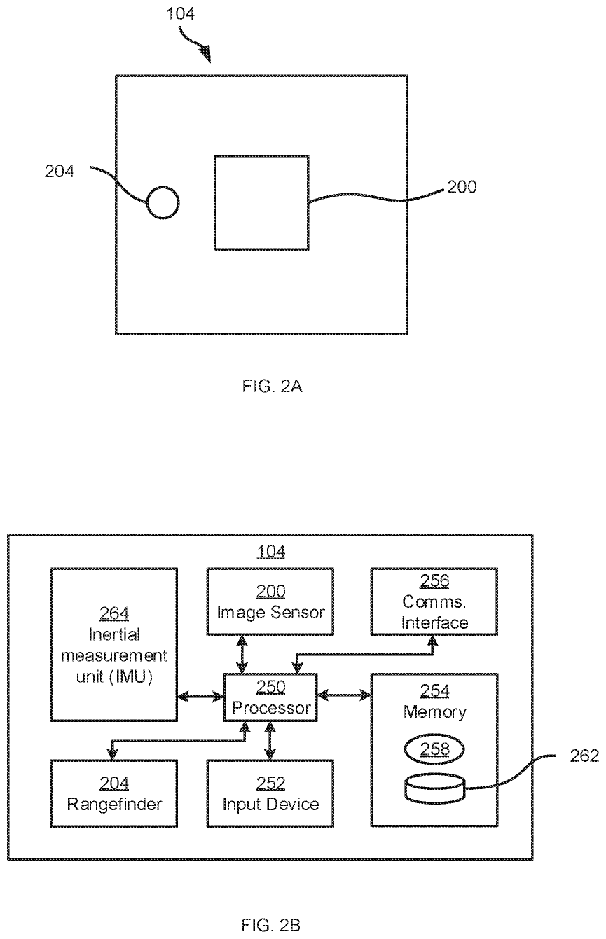

Turning now to FIGS. 2A and 2B, the dimensioning device 104 is shown in greater detail. Referring to FIG. 2A, a front view of the dimensioning device 104 is shown. The dimensioning device 104 includes an image sensor 200 and a rangefinder 204.

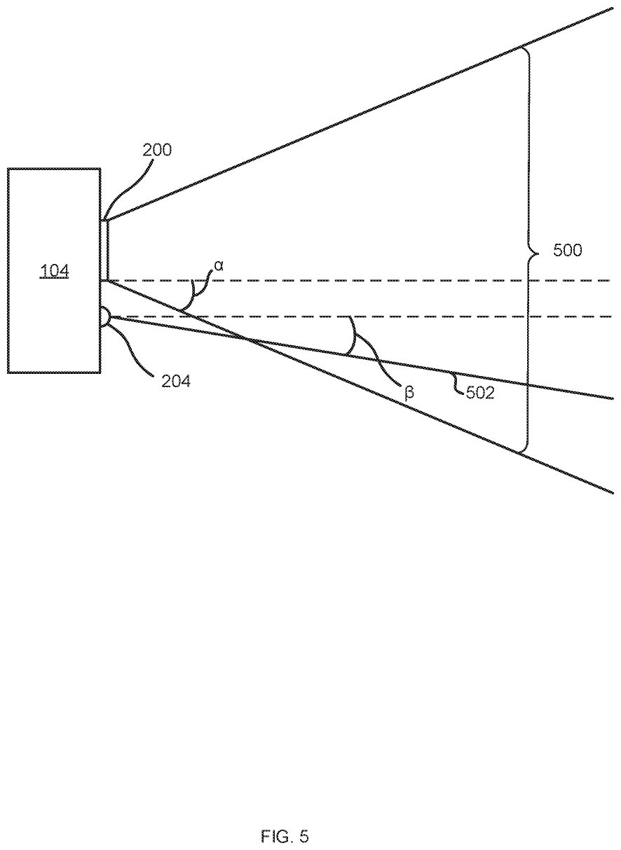

The image sensor 200 is disposed on the device 104 and is configured to capture image data representing at least the object (e.g. the box 120) towards which the device 104 is oriented for dimensioning. More particularly, in the present example, the image sensor 200 is configured to capture image data representing the box 120, including at least the corners 124 of the box 120 which are within the field of view of the image sensor 200. The image sensor 200 can be for example a digital color camera (e.g. configured to generate RGB images), a greyscale camera, an infrared camera, an ultraviolet camera, or a combination of the above. The image sensor 200 has a field of view defined by an angle α (illustrated in FIG. 5). In particular, objects within the angle a with respect to a normal of the image sensor 200 are captured by the image sensor 200. In some examples, the image sensor 200 can have different angles αᵥ and αₕ for vertical and horizontal fields of view respectively. The angle α for the device 104 may depend on properties of both the image sensor 200 and a lens or other optical element associated with the image sensor 200.

The rangefinder 204 also disposed on the device 104 is generally configured to determine a distance of an object (e.g. the box 120) towards which the device 104 is oriented for dimensioning. In the present example, the rangefinder 204 includes a laser configured to emit a laser beam towards the box 120. The laser beam forms a projection on the box 120, and the device 104 is configured to use image data including at least the box 120 and the projection to determine the distance of the projection, and hence the distance of the box 120. In other examples, the rangefinder 204 may employ time of flight methods, radar, sonar, lidar, or ultrasonic range finding techniques, or combinations of above, and hence the rangefinder 204 may include the required components to implement such range finding techniques.

In the present example, the rangefinder 204, and in particular, the laser, is disposed on the device 104 in a fixed spatial relationship relative to the image sensor 200. The laser includes an emission angle β (see FIG. 5) defining the angle of emission of a laser beam relative to a normal of the device 104 at the rangefinder 204. In some examples, the laser can have different emission angles βᵥ and βₕ for vertical and horizontal emission angles respectively. Generally, the emission angle β is less than the field of view angle α so that the projection of the laser beam emitted by the rangefinder 204 on the object for dimensioning is within the field of view of the image sensor 200.

Turning now to FIG. 2B, certain internal components of the device 104 are shown. The device includes a special-purpose controller, such as a processor 250 interconnected with a non-transitory computer readable storage medium, such as a memory 254. The memory 254 includes a combination of volatile memory (e.g. Random Access Memory or RAM) and non-volatile memory (e.g. read only memory or ROM, Electrically Erasable Programmable Read Only Memory or EEPROM, lash memory). The processor 250 and the memory 254 each comprise one or more integrated circuits.

The memory 254 stores computer readable instructions for execution by the processor 250. In particular, the memory 254 stores a control application 258 which, when executed by the processor 250, configures the processor 250 to perform various functions discussed below in greater detail and related to the dimensioning operation of the device 104. The application 258 may also be implemented as a suite of distinct applications in other examples. The processor 250, when so configured by the execution of the application 258, may also be referred to as a controller 250. Those skilled in the art will appreciate that the functionality implemented by the processor 250 via the execution of the application 258 may also be implemented by one or more specially designed hardware and firmware components, such as field-configurable gate arrays (FPGAs), application-specific integrated circuits (ASICs) and the like in other embodiments. In an embodiment, the processor 250 is a special-purpose dimensioning processor which may be implemented via dedicated logic circuitry of an ASIC, an FPGA, or the like in order to enhance the processing speed of the dimensioning calculations discussed herein.

The memory 254 also stores a repository 262 containing, for example, device data for use in dimensioning objects. The device data can include the relative spatial arrangement (i.e. the distance and direction between) the image sensor 200 and the rangefinder 204 on the device 104, the field of view angle(s) a and the laser emission angle(s) (3. In some examples, the repository 262 can also include image data captured by the image sensor 200 and object data, such as an object identifier, and object dimensions recorded upon completion of the dimensioning operation by the device 104.

The device 104 also includes a communications interface 256 interconnected with the processor 250. The communications interface 256 includes suitable hardware (e.g. transmitters, receivers, network interface controllers and the like) allowing the device 104 to communicate with other computing devices—particularly the server 101—via the link 107. The specific components of the communications interface 256 are selected based on the type of network or other links that the device 104 is required to communicate over. The device 104 can be configured, for example, to communicate with the server 101 via the link 107 using the communications interface 256 to communicate object data, image data and device data with the server 101.

The processor 250 is also connected to an input device 252 for receiving input from an operator. The input device 252 can be, for example, a trigger button, a touch screen, or the like, for initiating the dimensioning operation or for receiving other inputs. The processor 250 is also connected to an inertial measurement unit (IMU) 264. The IMU 264 can include, for example, one or more accelerometers, gyroscopes, magnetometers, or combinations of the above. The IMU 264 is generally configured to determine an orientation of the of the device 104 relative to the ground to allow the device 104 to compensate, in particular when the dimensioning operations are based on the object's position relative to a horizon line, vanishing points, and the like.

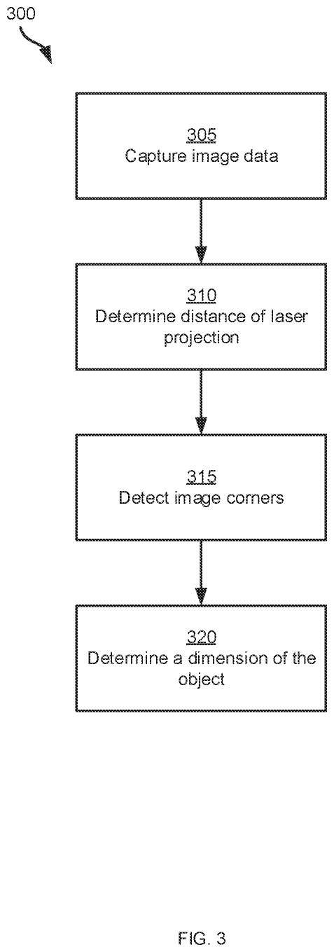

The functionality of the device 104, as implemented via execution of the application 258 by the processor 250 will now be described in greater detail, with reference to FIG. 3. FIG. 3 illustrates a method 300 of dimensioning objects, which will be described in conjunction with its performance in the system 100, and in particular by the device 104, with reference to the components illustrated in FIGS. 2A and 2B.

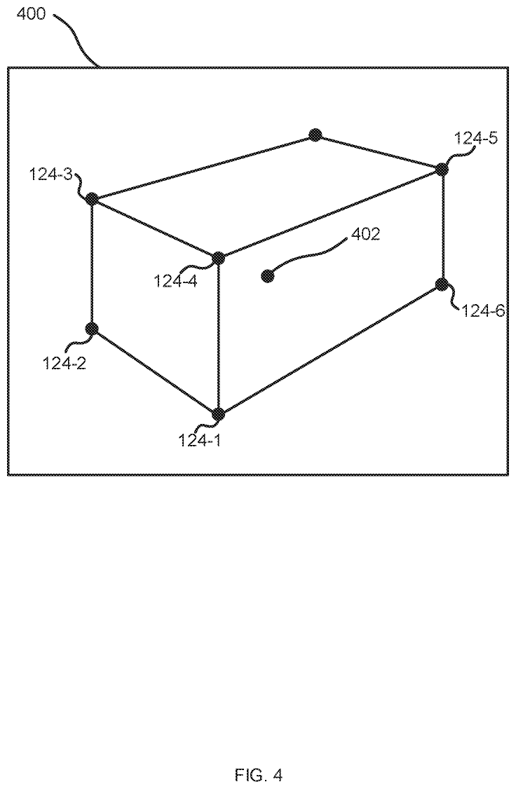

The method 300 begins at block 305 in response to an initiation signal, such as an input at the input device 252. For example, an operator may press a trigger button to initiate the method 300. At block 305, the device 104, and in particular the processor 250, is configured to control the image sensor 200 to capture image data representing the object (e.g. the box 120). Specifically, the image data includes at least the box 120 and the corners 124, or other predetermined features required for the dimensioning operations. In some examples, the image data can include seven corners 124, while in others, the image data can include only six corners 124 required for performing the dimensioning operations. For example, referring to FIG. 4, an example image 400 captured at block 305 is shown. In particular, the image 400 includes the corners 124-1, 124-2 and 124-6 which are on the ground, as well as the corresponding corners 124-3, 124-4, and 124-5, which respectively define vertical edges.

At block 310, the device 104 is configured to control the rangefinder 204 to determine a depth of the object from the device 104. For example, the image 400 captured at block 305 can include a projection 402 of the laser on the box 120. The device 104 therefore determines the depth of the projection 402, which in turn defines the depth of the object from the device 104 at that point. In some examples, the device 104 may be oriented, for example by an operator, such that the rangefinder 204 is directed at a predefined feature of the object to simplify dimensioning calculations. For example, the rangefinder 204 may be directed towards a nearest corner or edge of the box 120. The device 104 therefore determines the depth of the projection 402, which may then be used to determine the depth of the object, for example based on perspective theory, as will be described further below.

In some implementations, the device 104 may determine the depth of the projection 402 based on its spatial position within the image 400 and using the field of view angle α and the laser emission angle (3. Referring to FIG. 5, a schematic diagram illustrating the relationship between the field of view angle α and the laser emission angle β is shown. In particular, the position of the laser beam 502 (and hence the projection) within the field of view 500 varies as a function of distance from the device 104. For example, since the angle β is less than the angle α and based on the distance of the rangefinder 204 relative to the image sensor, the laser beam 502 appears closer to the middle of the field of view 500 further away from the device 104. Thus, the device 104 is first configured to determine the position of the projection 402 in the image 400.

In some examples, after determining the position of the projection 402 in the image 400, the device 104 may be configured to calculate the depth of the projection 402. In particular, the device 104, and in particular the processor 250, after determining the position of the projection 402 in the image 400, is configured to retrieve device characteristics including the relative spatial arrangement of the image sensor 200 and the rangefinder 204, the field of view angle α and the laser emission angle _{R} from the repository 262 or the server 101. The processor 250 is then configured to compute the depth of the projection 402 based on the position of the projection 402 in the image 400 and the retrieved device characteristics.

In other examples, the association between the position of the projection 402 in the image 400 and the depth of the projection 402 may be pre-computed based on the device characteristics, including the field of view angle α, the laser emission angle and the spatial arrangement of the image sensor 200 and the rangefinder 204. Accordingly, rather than storing the device characteristics, the repository 262 and/or the server 101 may store a table defining the depth of the projection 402 based on the position of the projection 402 in the image 400. Hence, after determining the position of the projection 402 in the image 400, the device 104 is configured to retrieve, from the repository 262 or the server 101, the depth of the projection 402 based on the position of the projection 402. Specifically, the device 104 may compare the determined position of the projection 402 to respective position values stored in a look-up table at the repository 262 or the server 101 to retrieve the depth of the projection 402.

In further examples, the device 104 may determine the depth of the object based on other range finding techniques, such as time of flight methods, sonar, radar, lidar, or ultrasonic methods, or combinations of the above.

Returning to FIG. 3, at block 315, the device 104 is configured to detect, in the image data captured at block 305, image corners representing corners of the object. In other words, the device 104 is configured to detect portions of the image data representing corners of the box 120. For example, the device 104 can be configured to corner detection algorithms on the image data. In other examples, the device 104 can first use edge detecting algorithms (e.g. by detecting gradient changes or the like) to detect edges of the box 120 and to subsequently identify points of intersections of the detected edges to define corners of the box 120. For example, referring to FIG. 4, the device 104 is configured to detect the corners 124 of the box 120.

In some implementations, the device 104 is configured to detect object contours, and edges to detect the image corners. For example, in some examples, the device 104 may detect corners based on methods described in Applicant-owned U.S. Pat. No. 6,685,095. For example, the device 104 can perform pre-processing operations (e.g. noise filtering and the like), edge detection in the image data and/or in one or more regions of the image data, contour tracking, clustering, and edge filtering. In some examples, the image data used may be color image data. Accordingly, the device 104 can employ parallel data processing, and computation optimization. Further, the device 104 can be configured to analyze and filter color channels (e.g. RGB channels) to synchronize shape, location, and other pattern data. The pre-processing operations, edge detection, contour tracking, clustering and edge filtering may thus be based on the synchronized pattern data obtained from the color image. The device 104 may then detect and identify key corners for dimensioning the object.

At block 320, the device 104 is configured to determine a dimension of the object based on the distance of the object determined at block 310 and the image corners detected at block 315. Specifically, the device 104 may select a subset of the image corners detected at block 315 and use geometrical relationships between the image corners to determine a dimension of the object.

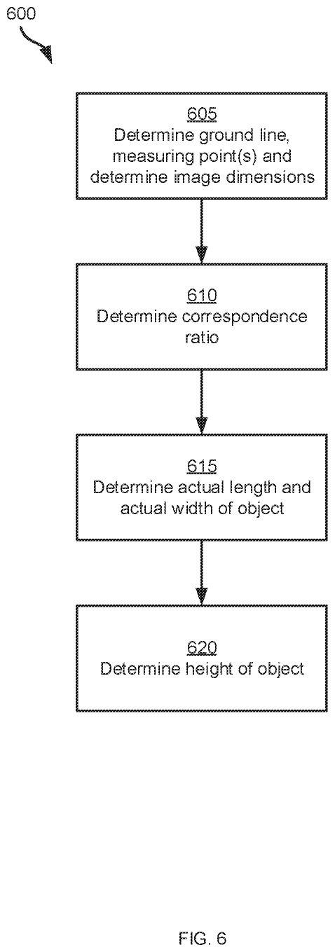

For example, turning now to FIG. 6, the performance of block 320 will be discussed in greater detail. FIG. 6 depicts an example method 600 of determining a dimension of the object at block 320. The method 600 will be described in conjunction with its performance in the system 100, and in particular by the device 104, with reference to the components illustrated in FIGS. 2A and 2B.

At block 605, the device 104 is configured to determine a ground line and one or more measuring points of the image and, using the ground line and the one or more measuring points, determine an image length and an image width of the object. The ground line and the one or more measuring points of the image may be determined based on the image corners detected at block 315 of the method 300. For example, the device 104 may select pairs of detected image corners which represent parallel edges to find one or more vanishing points of the image. The vanishing points may then be used to determine the horizon as well as to define the one or more measuring points, in accordance with perspective theory.

The ground line is defined by the intersection between the picture plane (i.e. the plane of the image data) and the ground plane on which the objects in the image rest (i.e. the ground). In particular, the ground line provides a reference line against which various lengths may be measured to provide true relative measurements, as will be described in further detail below. In some examples, the ground line may be selected to be a bottom edge of the image data, while in other examples, the ground line may be selected to be the line parallel to horizon which includes the nearest image corner (e.g. the image corner closest to the bottom edge of the image data). In some implementations, the device 104 may further be configured to normalize the field of view using data from the IMU 264. Specifically, the device 104 can retrieve orientation data indicative of an orientation of the device 104 relative to the earth and can apply angular corrections to the image data based on the retrieved orientation data, for example, to allow the ground line and horizon to be parallel to an edge of the image data used.

At block 605, the device 104 is also configured to determine one or more measuring points. The measuring points are defined in relation to vanishing points of the image, in accordance with perspective theory. In particular, the measuring points, together with the ground line, provide a measurement system which accounts for varying depths of lengths in the image.

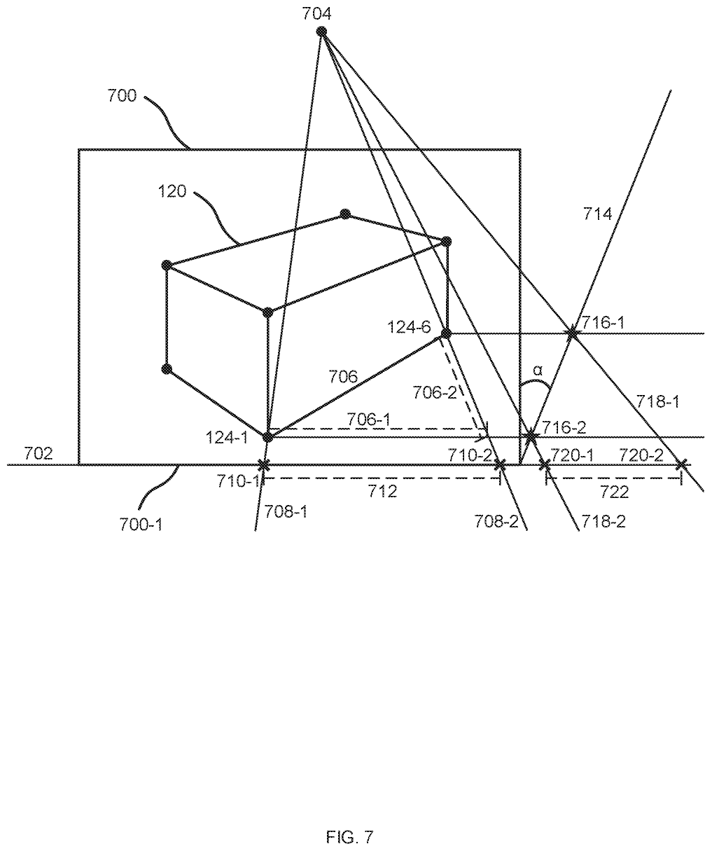

For example, FIG. 7 depicts an example image 700, including the box 120, the image corners 124, a ground line 702 and a measuring point 704. In particular, the ground line 702 in the present example extends along the bottom image edge 700-1 parallel to the horizon. The image 700 further includes an edge 706 from the image corner 124-1 to the image corner 124-6. The edge 706 can therefore be resolved into its component parts, in particular, a first component 706-1 parallel to the ground line 702, and a second component 706-2 perpendicular to the ground line. To determine the length of the edge 706, the components 706-1 and 706-2 can be mapped to the ground line 702 to allow them to be measured in the same scale.

Specifically, to map the first component 706-1 to the ground line 702, reference lines 708-1 and 708-2 are defined from the measuring point 704 through the corners 124-1 and 124-6 respectively. The points of intersection of the reference lines 708-1 and 708-2 with the ground line 702 define the points 710-1 and 710-2, respectively. The segment 712 along the ground line from the point 710-1 to the point 710-2 is the mapping of the first component 706-1 on the ground line 702. To map the second component 706-2, a field of view line 714 is extended from the bottom image edge 700-1 according to the angle α and reference points 716-1 and 716-2 are determined along the field of view line 714 based on the depth of the corners 124-1 and 124-6, respectively. That is, the reference points 716-1 and 716-2 may be defined as the points of intersection of the field of view line 714 and horizontal lines (i.e. lines parallel to the horizon and/or ground lines) containing the corners 124-1 and 124-6, respectively. Reference lines 718-1 and 718-2 are defined from the measuring point 704 through the reference points 716-1 and 716-2. The points of intersection of the reference lines 718-1 and 718-2 with the ground line 702 define the points 720-1 and 720-2, respectively. The segment 722 along the ground line from the point 720-1 to the point 720-2 is the mapping of the second component 706-2 on the ground line 702.

The segments 712 and 722 as measured along the ground line 702 provide an accurate relative measurement. That is, by using the measuring point 704, the ground line 702, and the field of view a, the segments 712 and 722 as measured along the ground line 702 account for the perspective view of the components 706-1 and 706-2 to allow them to be measured in the same scale. The components 706-1 and 706-2 are thus perpendicular components (component 706-1 is parallel to the ground line, and component 706-2 is perpendicular to the ground line), and hence, based on the Pythagorean theorem, the components 706-1 and 706-2 be used to compute the length of the edge 706 within that same scale (i.e. the scale of the ground line 702).

Returning to FIG. 6, at block 610, the device 104 is configured to determine a correspondence ratio of an image distance to an actual distance at the depth of the ground line 702 from the image sensor 200. For example, the device 104 may first employ similar techniques to use ground line and measuring point relationships to determine the depth of the ground line. In other examples, the device 104 may use the determined depth of the laser projection and the field of view to determine the depth of the ground line. Having determined the depth of the ground line, the device 104 can determine the actual distance captured by the image sensor 200 based on the known field of view angle α. The device 104 can thus determine that that a given image distance (e.g. the width of the image data, as represented in pixel or another suitable image coordinate system) the at that depth represents that actual distance. For example, it may be determined that 100 image pixels represents 20 centimeters of actual distance at the depth of the ground line, hence the determined correspondence ratio may be 0.2 centimeters/pixel.

At block 615, the device 104 is configured to determine an actual length and an actual width of the object. Specifically, having calculated the correspondence ratio at the depth of the ground line, as well as the image length and width at the scale of the ground line, the actual length and width can be determined by multiplying the image length and width by the correspondence ratio.

At block 620, the device 104 is configured to determine an actual height of the object. Specifically, the device 104 can be configured to determine the depth of an image corner (e.g. image corner 124-1), for example, using ground line and measuring point relationships. The device 104 can then determine a modified correspondence ratio at the determined depth of the image corner, for example, based on the correspondence ratio determined at block 610, and the relative depths of the ground line and the image corner. In some examples, it may be assumed that object's height is measured at the depth of the selected image corner (i.e. that the depth does not change along the height of the object as it does for the length and width). Accordingly, the device 104 can determine the image height of the object and use the modified correspondence ratio to determine the object height.

In some examples, a single height may be determined for a single image corner. That is, it may be assumed that the object has the same height at each corner. In other examples, the height may be measured at each visible corner on the ground plane. The device 104 may select the corners, for example based on a threshold distance from a bottom edge of the image. Thus, a pallet having objects stacked to form different heights at different corners of the pallet may have different determined heights at each corner.

Variations to the above systems and methods are contemplated. For example, in some embodiments, the determination of an actual length, width, and height of an object at blocks 615 and 620 of the method 600 may not be computed directly. For example, in some applications, objects to be dimensioned may be selected from a finite number of objects, each having a predefined size. Accordingly, key image distances may uniquely identify each of the predefined sizes. The association between the key image distances and the predefined size (e.g. the length, width and height of the object) may be stored in the repository 262 and/or the server 101.

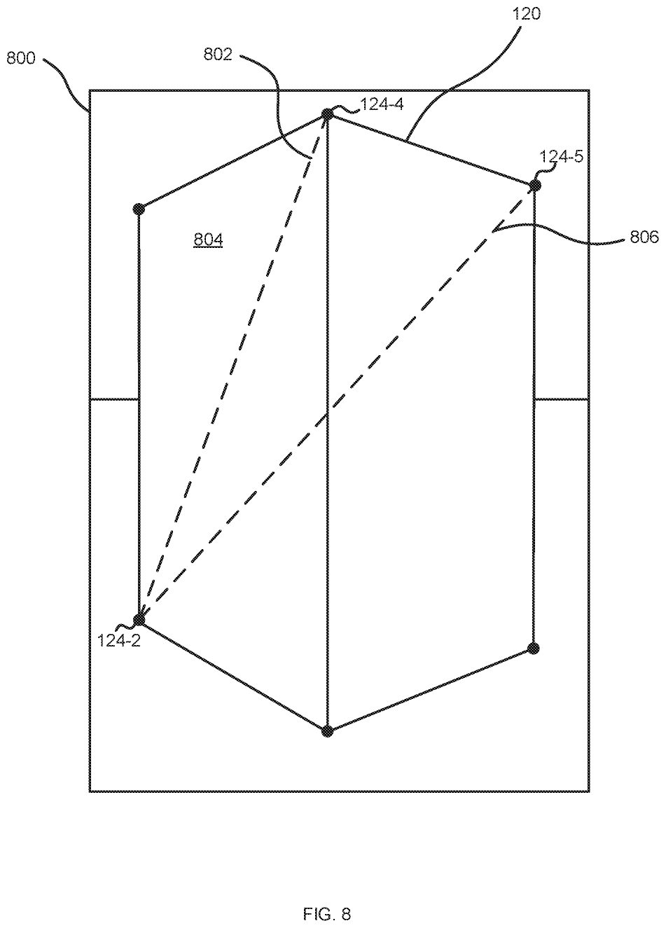

Hence, at block 605, the device 104 may be configured to determine the key image distances. For example, the device 104 may be configured to determine a first image diagonal distance from one image corner to another image corner across a face of the object and a second image diagonal distance from one image corner to another image corner through the object. For example, referring to FIG. 8, an example image 800 is depicted. The image 800 includes the box 120 and the corners 124. At block 320 of the method, the device 104 is configured to select corners 124-2 and 124-4, which define a first image diagonal distance 802 across a face 804 of the box 120. That is, the selected corners 124-2 and 124-4 represent a diagonal line across the face 804 of the box 120. The device 104 is further configured to select corners 124-2 and 124-5, which define a second image diagonal distance 806 through the box 120. That is, the selected corners 124-2 and 124-5 represent a diagonal line through the box 120. By using ground line and measuring point relationships to determine the image diagonal distances within the same scale, the image diagonal distances 802 and 806 may together uniquely identify the size of the box 120. Hence, at block 615 and 620, the device 104 may use the correspondence ratio to determine the actual image diagonal distances and retrieve the actual length, width and height of the box 120 based on the actual image diagonal distances. Specifically, the device 104 may compare the first image diagonal distance 802 and the second image diagonal distance 806 to respective image diagonal distance values stored in a look-up table at the repository 262 or the server 101 to retrieve the actual length, width and height of the box 120.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, in a dimensioning device, of dimensioning an object, the method comprising:
controlling an image sensor of the dimensioning device to capture image data representing the obj ect;
controlling a rangefinder of the dimensioning device to determine an object depth relative to the image sensor;
detecting, in the image data, image corners representing corners of the object;
determining a ground line and one or more measuring points of the image data based on the detected image corners;
determining one or more image dimensions of the object based on the ground line and the one or more measuring points;
determining a correspondence ratio of an image distance to an actual distance represented by the image distance based on the object depth, the ground line, and the one or more measuring points; and
determining one or more dimensions of the object based on the one or more image dimensions and the correspondence ratio.

2. The method of claim 1, wherein controlling the rangefinder to determine the object depth comprises:
controlling a laser of the rangefinder to emit a laser beam forming a projection, wherein the image data captured by the image sensor includes the projection;
determining a position of the projection in the image data;
determining a projection depth based on the determined position of the projection; and
determining the object depth based on the projection depth and the position of the projection relative to the object in the image data.

3. The method of claim 2, wherein determining the projection depth comprises:
retrieving device characteristics including a field of view angle of the image sensor, an emission angle of the laser, and a spatial arrangement of the image sensor and the rangefinder; and
computing the projection depth based on the determined position of the projection and the retrieved device characteristics.

4. The method of claim 2, wherein determining the projection depth comprises retrieving the projection depth based on a comparison of the determined position of the projection to respective position values stored in a look-up table, wherein the projection depth stored in the look-up table is pre-computed based on device characteristics including a field of view angle of the image sensor, an emission angle of the laser, and a spatial arrangement of the image sensor and the rangefinder.

5. The method of claim 1, wherein controlling the rangefinder to determine the object depth comprises controlling the rangefinder to determine the object depth at a predefined feature of the object.

6. The method of claim 1, further comprising:
prior to determining the ground line and the one or more measuring points, retrieving orientation data from an inertial measurement unit of the dimensioning device; and
applying angular corrections to the image data based on the retrieved orientation data.

7. The method of claim 1, wherein determining one or more image dimensions comprises:
determining a first image diagonal distance from a first image corner to a second image corner, the first image diagonal distance representing a first diagonal line across a face of the object; and
determining a second image diagonal distance from the first image corner to a third image corner, the second image diagonal distance representing a second diagonal line through the object; and
wherein determining the one or more dimensions comprises retrieving the one or more dimensions based on a comparison of the first image diagonal distance and the second image diagonal distance to respective image diagonal distance values stored in a look-up table.

8. A dimensioning device comprising:
an image sensor disposed on the dimensioning device, the image sensor configured to capture image data representing an object for dimensioning;
a rangefinder disposed on the dimensioning device, the rangefinder configured to determine an object depth relative to the image sensor;
a dimensioning processor coupled to the image sensor and the rangefinder, the dimensioning processor configured to:
control the image sensor to capture image data representing the object;
control the rangefinder to determine the object depth;
detect, in the image data, image corners representing corners of the object;
determine a ground line and one or more measuring points of the image data based on the detected image corners;
determine one or more image dimensions of the object based on the ground line and the one or more measuring points;
determine a correspondence ratio of an image distance to an actual distance represented by the image distance based on the object depth, the ground line, and the one or more measuring points; and
determine one or more dimensions of the object based on the one or more image dimensions and the correspondence ratio.

9. The dimensioning device of claim 8, wherein the dimensioning processor is configured to control the rangefinder to determine the object depth by:
controlling a laser of the rangefinder to emit a laser beam forming a projection, wherein the image data captured by the image sensor includes the projection;
determining a position of the projection in the image data;
determining a projection depth based on the determined position of the projection; and
determining the object depth based on the projection depth and the position of the projection relative to the object in the image data.

10. The dimensioning device of claim 9, wherein the dimensioning processor is configured to determine the projection depth by:
retrieving device characteristics including a field of view angle of the image sensor, an emission angle of the laser, and a spatial arrangement of the image sensor and the rangefinder; and
computing the projection depth based on the determined position of the projection and the retrieved device characteristics.

11. The dimensioning device of claim 9, wherein the dimensioning processor is configured to determine the projection depth by retrieving the projection depth based on a comparison of the determined position of the projection to respective position values stored in a look-up table, wherein the projection depth stored in the look-up table is pre-computed based on device characteristics including a field of view angle of the image sensor, an emission angle of the laser, and a spatial arrangement of the image sensor and the rangefinder.

12. The dimensioning device of claim 8, wherein the dimensioning processor is configured to determine the object depth by controlling the rangefinder to determine the object depth at a predefined feature of the object.

13. The dimensioning device of claim 8, further comprising an inertial measurement unit configured to obtain orientation data of the dimensioning device, and wherein the dimensioning processor is further configured to:
prior to determining the ground line and the one or more measuring points, retrieve the orientation data from the inertial measurement unit; and
apply angular corrections to the image data based on the retrieved orientation data.

14. The dimensioning device of claim 8, wherein the dimensioning processor is configured to determine the one or more image dimensions by:
determining a first image diagonal distance from a first image corner to a second image corner, the first image diagonal distance representing a first diagonal line across a face of the object; and
determining a second image diagonal distance from the first image corner to a third image corner, the second image diagonal distance representing a second diagonal line through the object; and
wherein determining the one or more dimensions comprises retrieving the one or more dimensions based on a comparison of the first image diagonal distance and the second image diagonal distance to respective image diagonal distance values stored in a look-up table.

15. A non-transitory computer-readable medium storing a plurality of computer readable instructions executable by a dimensioning controller, wherein execution of the instructions configures the dimensioning controller to:
control an image sensor of a dimensioning device to capture image data representing an object;
control a rangefinder of the dimensioning device to determine an object depth relative to the image sensor;
detect, in the image data, image corners representing corners of the object;
determine a ground line and one or more measuring points of the image data based on the detected image corners;
determine one or more image dimensions of the object based on the ground line and the one or more measuring points;
determine a correspondence ratio of an image distance to an actual distance represented by the image distance based on the object depth, the ground line, and the one or more measuring points; and
determine one or more dimensions of the object based on the one or more image dimensions and the correspondence ratio.

16. The non-transitory computer-readable medium of claim 15, wherein execution of the instructions further configures the dimensioning controller to:
control a laser of the rangefinder to emit a laser beam forming a projection, wherein the image data captured by the image sensor includes the projection;
determine a position of the projection in the image data;
determine a projection depth based on the determined position of the projection; and
determine the object depth based on the projection depth and the position of the projection relative to the object in the image data.

17. The non-transitory computer-readable medium of claim 16, wherein execution of the instructions further configures the dimensioning controller to:
retrieve device characteristics including a field of view angle of the image sensor, an emission angle of the laser, and a spatial arrangement of the image sensor and the rangefinder; and
compute the projection depth based on the determined position of the projection and the retrieved device characteristics.

18. The non-transitory computer-readable medium of claim 16, wherein execution of the instructions further configures the dimensioning controller to retrieve the projection depth based on a comparison of the determined position of the projection to respective position values stored in a look-up table, wherein the projection depth stored in the look-up table is pre-computed based on device characteristics including a field of view angle of the image sensor, an emission angle of the laser, and a spatial arrangement of the image sensor and the rangefinder.

19. The -transitory computer-readable medium of claim 15, wherein execution of the instructions further configures the dimensioning controller to control the rangefinder to determine the object depth at a predefined feature of the object.

20. The -transitory computer-readable medium of claim 15, wherein execution of the instructions further configures the dimensioning controller to:
prior to determining the ground line and the one or more measuring points, retrieve orientation data from an inertial measurement unit of the dimensioning device; and
apply angular corrections to the image data based on the retrieved orientation data.

21. The -transitory computer-readable medium of claim 15, wherein execution of the instructions further configures the dimensioning controller to:
determine a first image diagonal distance from a first image corner to a second image corner, the first image diagonal distance representing a first diagonal line across a face of the object; and
determine a second image diagonal distance from the first image corner to a third image corner, the second image diagonal distance representing a second diagonal line through the object; and
wherein determining the one or more dimensions comprises retrieving the one or more dimensions based on a comparison of the first image diagonal distance and the second image diagonal distance to respective image diagonal distance values stored in a look-up table.
